(19) United States
(12) Patent Application Publication
(10) Pub. No.: US 2016/0029078 A1
(43) Pub. Date: Jan. 28, 2016

(54) Set-Top Box for Changing Channels and System and Method for Use of Same

(71) Applicant: Enseo, Inc., Richardson, TX (US)

(72) Inventors: Vanessa Ogle, Fairview, TX (US); Thomas R. Miller, Plano, TX (US); William C. Fang, Richardson, TX (US)

(21) Appl. No.: 14/811,585

(22) Filed: Jul. 28, 2015

Related U.S. Application Data
(60) Provisional application No. 62/029,781, filed on Jul. 28, 2014.

(51) Int. Cl. H04N 21/443; H04N 21/45; H04N 21/442; H04N 21/426; H04N 5/50

(52) U.S. Cl. CPC H04N 21/4435; H04N 21/4263; H04N 5/50; H04N 21/44222; H04N 21/4516

(57) ABSTRACT

A set-top box for changing channels and method for use of the same are disclosed. In one embodiment, the set-top box includes a television input that is configured to receive a source signal, which includes at least first and second channels, from an external source and tune the source signal in order to forward the tuned signal to a television. Within the set-top box, memory is accessible to the processor such that processor-executable instructions, when executed, cause the processor to save in a buffer the at least partially tuned second channel beginning at a recent periodic, sequential signal access point. In response to receiving a channel change instruction when the television tuner is forwarding the tuned first channel signal, the set-top box causes the television tuner to forward the fully tuned signal based on the second channel stored in the buffer beginning at the recent periodic, sequential signal access point.

### PRIORITY STATEMENT & CROSS-REFERENCE TO RELATED APPLICATIONS

This application claims priority from co-pending U.S. Patent Application No. 62/029,781, entitled “Set-Top Box for Changing Channels and System and Method for Use of Same” and filed on Jul. 28, 2014, in the name of Vanessa Ogle; which is hereby incorporated by reference for all purposes.

### TECHNICAL FIELD OF THE INVENTION

This invention relates, in general, to set-top boxes and, in particular, to set-top boxes for changing channels and systems and methods for use of the same that address the total duration of time from a channel change button being pressed to the new channel being displayed.

### BACKGROUND OF THE INVENTION

Without limiting the scope of the present invention, the background will be described in relation to televisions in the hospitality lodging industry, as an example. “Zap time” is the total duration of time from a television viewer pressing the channel change button, to the picture of the new channel being displayed with full resolution, along with corresponding audio. Zap time delays exist in all television systems, due to network factors, acquisition factors and buffering/decoding, for example. Zap time is greater in digital televisions, however, which are very common in hotels and other hospitality lodging establishments. As a result of limitations in existing technology, zap time is a frequent complaint and source of aggravation by guests staying in hospitality lodging establishments. Accordingly, there is a need for improved systems and methods for mitigating zap time delays.

### SUMMARY OF THE INVENTION

It would be advantageous to reduce zap time in hospitality lodging establishments as well as any television viewing environment. It would also be desirable to enable a computer-based solution that would mitigate tuning-related factors, such as buffering and decryption delays. To better address one or more of these concerns, a set-top box for changing channels and systems and methods for use of the same are disclosed. In one embodiment of the set-top box, the set-top box includes a television input that is configured to receive a source signal, which includes at least first and second channels, from an external source and tune the source signal in order to forward the tuned signal to a television. Within the set-top box, memory is accessible to a processor and the memory includes processor-executable instructions that, when executed, cause the processor to save in a buffer the tuned second channel beginning at a recent periodic, sequential signal access point. In response to receiving a channel change instruction when the television tuner is forwarding the tuned first channel signal, the set-top box causes the television tuner to forward the fully tuned signal based on the second channel stored in the buffer beginning at the recent periodic, sequential signal access point. These and other aspects of the invention will be apparent from and elucidated with reference to the embodiments described hereinafter.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is schematic diagram depicting one embodiment of a system for changing channels on a television according to the teachings presented herein;

FIG. 2A is a front elevation view of one embodiment of a set-top box depicted in FIG. 1 in further detail;

FIG. 2B is a rear elevation view of the set-top box depicted in FIG. 2A;

FIG. 3 is a functional block diagram depicting one embodiment of the set-top box presented in FIGS. 2A and 2B;

FIG. 4A is a functional block diagram depicting one embodiment of a channel change operation, prior to the channel change;

FIG. 4B is a functional block diagram depicting the channel change operation presented in FIG. 4A, at the channel change;

FIG. 5 is a functional block diagram depicting one embodiment of the signal processing and storage allocation accompanying the change operation presented in FIG. 4A and FIG. 4B; and

FIG. 6 is a flow chart depicting one embodiment of a method for changing channels according to the teachings presented herein.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention, and do not delimit the scope of the present invention.

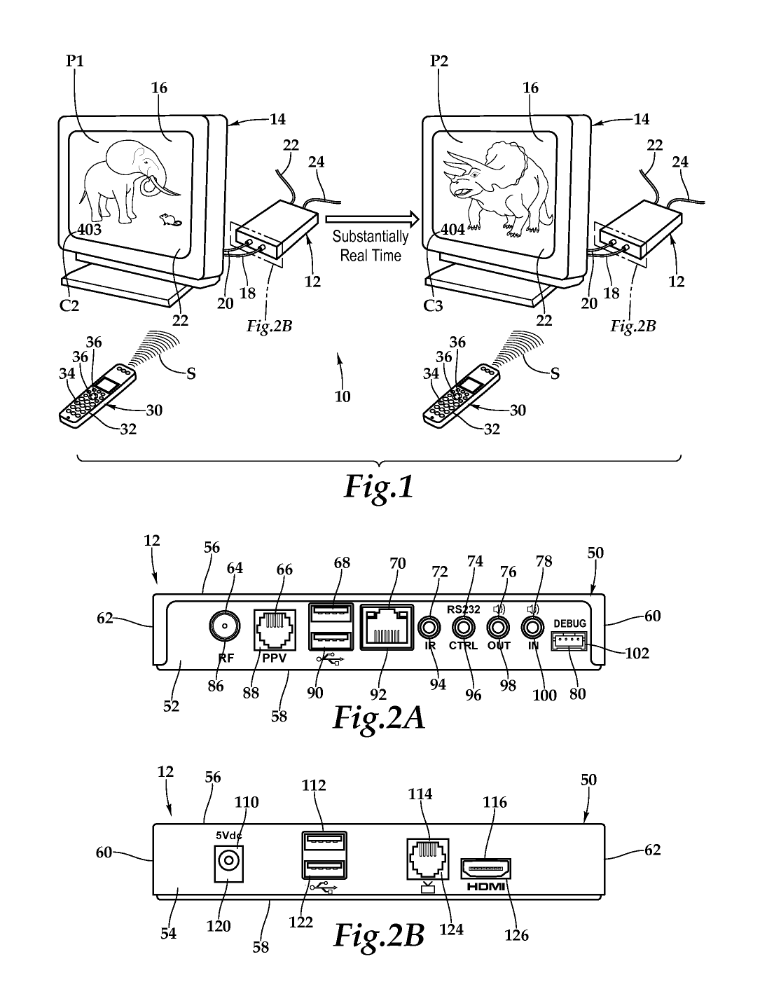

Referring initially to FIG. 1, therein is depicted one embodiment of system for changing channels, which is schematically illustrated and designated 10. As shown, the system 10 includes a set-top box 12 and a display illustrated as television 14 having a screen 16. A connection, which is depicted as an HDMI connection 18, connects the set-top box 12 to the television 14. Other connections include a power cable 20 coupling the set-top box 12 to a power source, a coaxial cable 22 coupling the set-top box 12 to external cable source, and a category five (Cat 5) cable 24 coupling the set-top box 12 to external pay-per-view source at a hotel or other lodging establishment, for example. It should be appreciated that the cabling connected to the set-top box will depend on the environment and application and the cabling connections presented in FIG. 1 are depicted for illustrative purposes. Further, it should appreciated that the positioning of the set-top box 12 will vary depending on environment and application and, with certain functionality, the set-top box 12 may be placed more discretely behind the television 14.

A television remote control 30 includes an array of buttons 32 for adjusting various settings such as television channel and volume. Among the array of buttons 32, the television remote control 30 is depicted as including channel change buttons 34, up channel change button 36, and a down channel change button 38. In one embodiment, the television remote control 30 may be a consumer infrared (IR) or other protocol, such as Bluetooth, device configured as a small wireless handheld object that issues commands from a distance to the set-top box 12 in order to control the television 14 via the set-top box 12, for example.

In one implementation, as illustrated, channel 403, as indicated by C2, is broadcasting a program, as indicated by P1, and this program P1 is on the screen 16 of the television 14. A user presses the channel up button 36 on the remote control 30 and a signal S, which includes instructions for the channel C2 to be changed one channel upward, is transmitted from the remote control 30 to the set-top box 12. As shown in FIG. 1, the channel is changed from channel 403 to channel 404, as indicated by C3, with program P2. The channel change occurs in substantially real time with zap time being mitigated, as will be discussed in further detail hereinbelow.

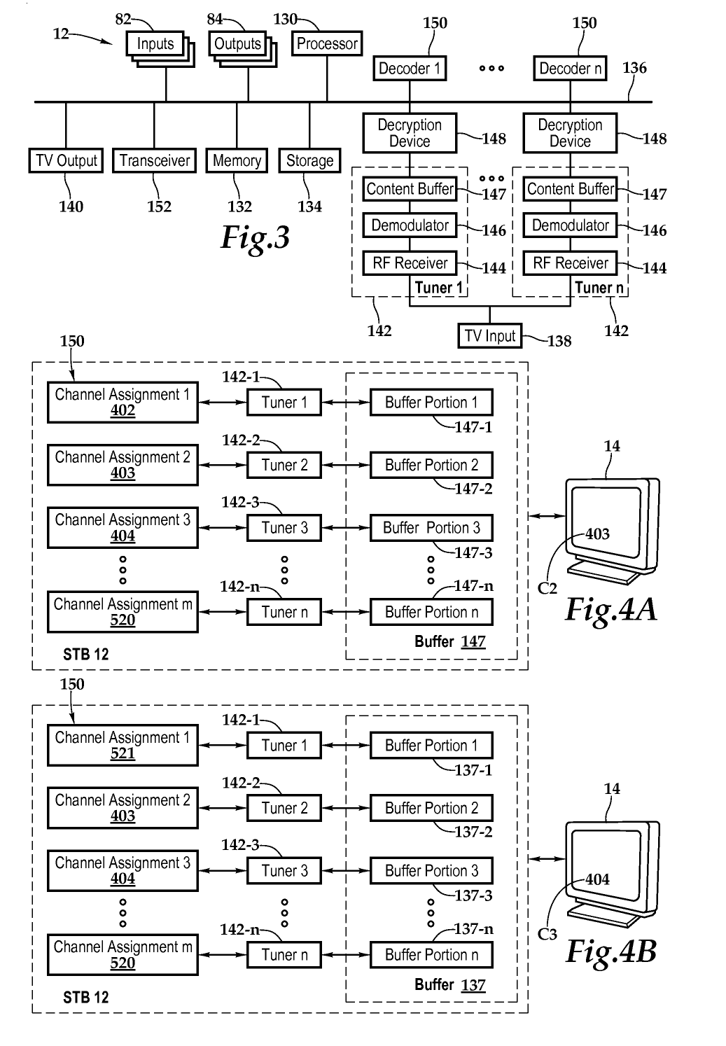

Referring to FIG. 2A, FIG. 2B, and FIG. 3, as used herein, set-top boxes, back boxes and set-top/back boxes may be discussed set-top back boxes. By way of example, the set-top box 12 may be a set-top unit that is an information appliance device that generally contains set-top box functionality including having a television-tuner input and displays output through a connection to a display or television set and an external source of signal, turning by way of tuning the source signal into content in a form that can then be displayed on the television screen or other display device. Such set-top boxes are used in cable television, satellite television, and over-the-air television systems, for example.

The set-top box 12 includes a housing 50 having a rear wall 52, front wall 54, top wall 56, bottom base 58, and two sidewalls 60, 62. It should be appreciated that front wall, rear wall, and side wall are relative terms used for descriptive purposes and the orientation and the nomenclature of the walls may vary depending on application. The front wall includes various ports, ports 64, 66, 68, 70, 72, 74, 76, 78, and 80 that provide interfaces for various interfaces, including inputs and outputs. In one implementation, as illustrated, the ports 64 through 80 include inputs 82 and outputs 84 and, more particularly, an Rf input 86, a RJ45 input 88, universal serial bus (USB) input/outputs 90, an Ethernet category 5 (Cat 5) coupling 92, an internal reset 94, an RS232 control 96, an audio out 98, an audio in 100, and a debug/maintenance port 102. The front wall 54 also includes various inputs 82 and outputs 84. More particularly, ports 110, 112, 114, and 116 include a 5V dc power connection 120, USB inputs/outputs 122, an RJ-45 coupling 124, and an HDMI port 126. It should be appreciated that the configuration of ports may vary with the set-top box depending on application and context.

Within the housing 50, a processor 130, memory 132, storage 134, the inputs 82, and the outputs 84 are interconnected by a bus architecture 136 within a mounting architecture. The processor 130 may process instructions for execution within the computing device, including instructions stored in the memory 132 or in storage 134. The memory 132 stores information within the computing device. In one implementation, the memory 132 is a volatile memory unit or units. In another implementation, the memory 132 is a non-volatile memory unit or units. Storage 134 provides capacity that is capable of providing mass storage for the set-top box 12. Various inputs 82 and outputs 84 provide connections to and from the computing device, wherein the inputs 82 are the signals or data received by the set-top box 12, and the outputs 84 are the signals or data sent from the set-top box 12.

A television content signal input 138 and a television output 140 are also secured in the housing 50 in order to receive content from a source in the hospitality property and forward the content, including external content such as cable and satellite and pay-per-view (PPV) programming, to the television located within the hotel room. More specifically, the television input 138 receives a source signal from an external source. The source signal includes multiple channels and each of the multiple channels has periodic, sequential signal access points that permit tuning initiation. Each tuner 142 is configured to receive and tune a channel from the source signal. As shown, each tuner 142 includes an RF receiver 144, a demodulator 146, and a content buffer 147 associated with a decryption device 148 and a decoder 150 in order to provide a tuned channel. The radio frequency (RF) receiver 144 is the portion of the tuner that receives RF transmissions and converts the selected carrier frequency and its associated bandwidth into a fixed frequency that is suitable for further processing. The demodulator 146 is an electronic circuit that is used to recover the information content from the modulated carrier wave provided by the RF receiver 144. The contact buffer 147 stores the signal and may be independent storage or associated with or form a portion of the memory 132 or 134. In one embodiment, the content buffer 147 may be a first-in-first-out (FIFO) buffer, having one per tuner, in the memory. The content buffer may hold at least one access point for the incurring signal streams when the buffer is assigned to the correct viewing channel, the processor may quickly jump to the access point in the buffer and start the content decryption and decoding process. The decryption device 148 then decrypts the demodulated signal before decoding at the decoder 150. It should be appreciated that although a particular architecture of tuner, RF receiver, demodulator, decryption device and decoder is depicted, other architectures are within the teachings presented herein.

A transceiver 152 is associated with the set-top box 12 and communicatively disposed with the bus 136. As shown the transceiver may be internal, external, or a combination thereof to the housing. Further, the transceiver 152 may be a transmitter/receiver, receiver, or an antenna for example. Communication between various amenities in the hotel room and the set-top box 12 may be enabled by a variety of wireless methodologies employed by the transceiver 152, including 802.11, 3G, 4G, Edge, WiFi, ZigBee, near field communications (NFC), Bluetooth low energy and Bluetooth, for example. Also, infrared (IR) may be utilized.

The memory 132 and storage 134 are accessible to the processor 130 and include processor-executable instructions that, when executed, cause the processor 130 to execute a series of operations. The processor-executable instructions dynamically assign each of the tuners 142 (e.g., tuner-1 through tuner-n) to one of channels. For each of the tuners 142, the processor-executable instructions buffer in the content buffer 147 at least a partially tuned channel. By way of example, the channel may be processed by the RF receiver 144 and the demodulator 146 prior to be stored in the content buffer 147. For each of the tuners, the processor-executable instructions track in the content buffer 147 at least partially tuned channel beginning at a recent periodic, sequential signal access point. In response to receiving a channel change instruction via the transceiver 152, for example, to change to a requested channel, the instructions locate the buffered storage portion associated with the tuner assigned to the requested channel and cause the at least partially tuned channel beginning at the recent periodic, sequential signal access point to be fully tuned and then forwarded by way of the TV output 140 to the television 14. Transforming or processing the at least partially tuned channel to be a fully tuned channel may involve use of the decryption device 148 and the decoder 150, for example.

Referring now to FIGS. 4A and 4B, wherein one embodiment of a channel change operation is depicted in additional detail. As shown, in FIG. 4A, channel assignments 150 are made for each tuner 142, including tuner-1 (142-1), tuner-2 (142-2), tuner-3 (142-3), through tuner-n (142-n). More specifically, the tuners 142-1 through 142-n are assigned channels 402, 403, 404, and 520, respectively. It should be appreciated that the number of channels m may be much greater than the number of tuners n, such that m>>n. Further, each tuner 142 is assigned a buffer portion 137-1, 137-2, 137-3, through 137-n, of content buffer 137. As each tuner receives a channel of the source signal, the channel is at least partially tuned and stored at the respective buffer portion. By way of example, tuner-1 is tuned to channel 402 and partially tunes this channel and stores the at least partially tuned channel in buffer portion 1.

As depicted, the television 14 is presently configured for viewing channel 403. At FIG. 4B, the channel is changed from “403” to “404” and, accordingly, the at least partially tuned channel at the buffer portion associated with tuner 3, which is assigned to channel 404 is accessed. The signal is then fully tuned and provided to the television 14. By having the channel already partially tuned, the zap time or delay associated with changing channels is minimized.

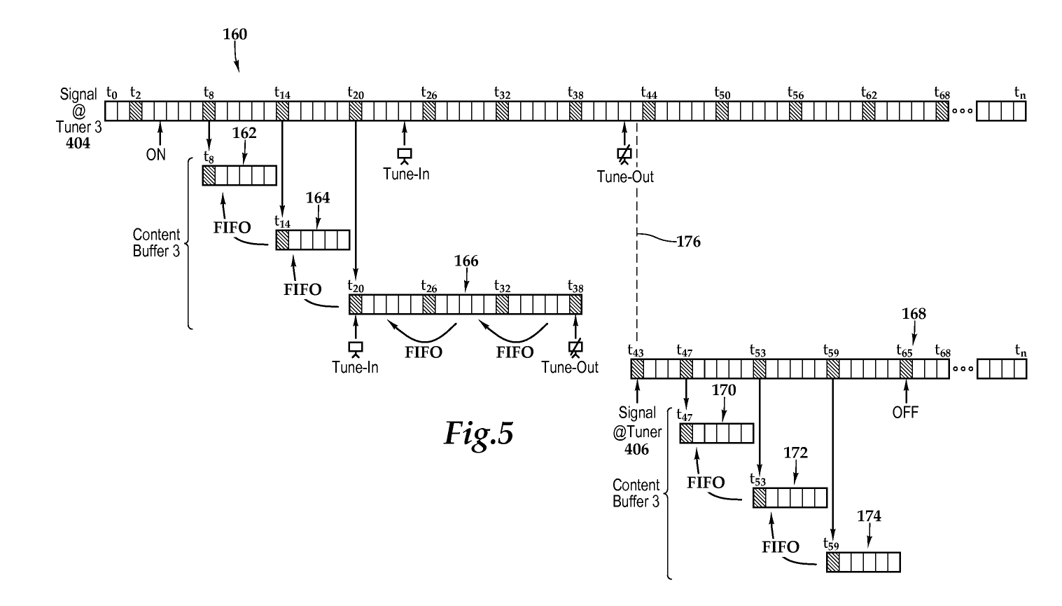

Referring now to FIG. 5, wherein one embodiment of the signal processing and storage allocation accompanying the change operation presented in FIG. 4A and FIG. 4B is further illustrated. A signal 160, which corresponds to channel 404, is receivable by the set-top box and, as shown, begins at time to and continues to time tₙ. As illustrated, tuner 3 receives signal 160 beginning at time t₄ upon the television tuning capability being turned ON at the set-top box or television, for example. Periodic, sequential signal access points are positioned within the signal 160 at various times, including t₂, t₈, t₁₄, t₂₀, t₂₆, t₃₂, and continuing with the spacing of 6 second increments between sequential signal access points. As alluded, each of the periodic, sequential signal access points provides a location at which tuning of the signal may begin. Tuning may include RF receiving, demodulation, decryption, and decoding, for example.

With respect to the signal 160, beginning at time t₈ with the sequential signal access point thereat, the set-top box buffers in the buffer portion 3 the at least partially tuned channel 160 as signal portion 162 in the buffer portion 3. As shown, in one embodiment, the buffering of the signals occurs in a first-in-first-out (FIFO) manner. As previously discussed, buffer portion 3 continues to keep signal portions, including tacking and identification thereof, beginning at periodic, sequential signal access points until the channel 404 is selected for viewing. By way of example, buffer portion 3 stores a signal portion 164 beginning at time t₁₄ and continuing until time t₁₉. Further, signal portion 166 is stored in buffer portion 3 beginning with the sequential signal access point at time t₂₀ and preliminary tuning performed on the signal portion 166.

The set-to box tracks in the storage and buffering the at least partially tuned channel 160 beginning at a recent periodic, sequential signal access point, such as periodic sequential signal access points t₈, t₁₄, and t₂₀, with the periodic sequential signal access point t₂₀ being the recent periodic sequential signal access point upon the set-top box receiving a signal to tune-in to the channel represented by the signal 160 at time t₂₄. At time t₂₄, the set-top box in response to receiving a channel change instruction, accesses from the buffer portion 3 the at least partially tuned channel 160 beginning at the recent periodic, sequential signal access point at time t₂₀. Thereafter, the set-top box transforms the partially tuned channel 160 to a fully tuned channel signal and forwards, via the television output, the fully tuned channel signal to the television.

That is, in the illustrated embodiment, at time t₂₄ the set-top box is tuned-in to channel 404. Thereafter, the set-top box accesses the signal portion 166 stored in buffer portion 3 that the set-top box was tracking. At the time t₂₄, the set-top box retrieves the partially tuned signal at time t₂₀ in the buffer portion 3 and completes the tuning. The set-top box then forwards the fully tuned signal beginning at time t₂₀ to the display or television. The set-top box continues to receive and perform a preliminary tuning on the signal 160, with storage and buffering of signal portion 166. Further, the set-top box continues to retrieve, perform a secondary tuning on the signal portion, and forward the fully tuned signal through time t₄₂, which corresponds to time t₃₈ in the signal portion 166. At time t₄₂, channel 404 is tuned-out, due to a channel change or other event, as indicated by line 176.

As shown, the at time t₄₃, the buffer portion is assigned to channel 406 and signal 168 is received. Within the signal 168, signal access points are at times t₄₃, t₄₇, t₅₃, t₅₉ and so on. Accordingly, signal portions 170, 172, and 174 are sequentially stored, buffered, and preliminary tuned at signal portion 3 in preparation for channel 406 being accessed for viewing by the set-top box. It should be appreciated that although only a single buffer portion is depicted in FIG. 5, multiple buffer portions are within the teachings presented herein and the assignment of channels to the buffer portions may be based various schemes, including storing and pre-tuning the channel corresponding to the “channel-up” button, the “channel-down” button, a channel two “channel-up” button executions away, or a frequently viewed channel, by way of example.

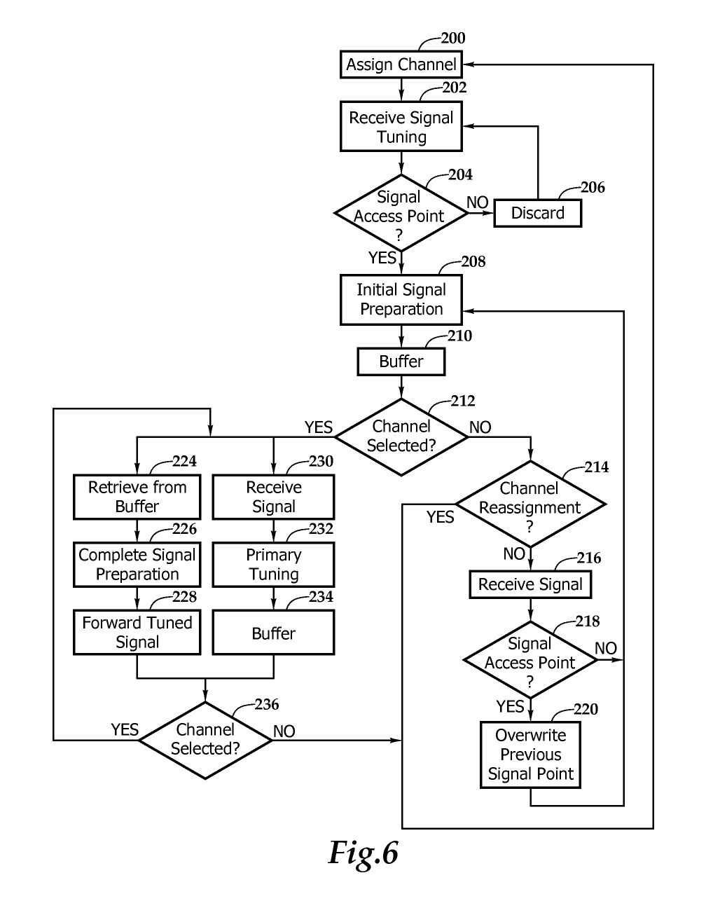

FIG. 6 illustrates one embodiment of a method for changing channels according to the teachings presented herein. At block 200, channel assignments are made to buffer portions of the set-top box. Continuing the description of the methodology with respect to a single channel assignment made to a buffer portion of the set-top box, at block 202, the set-top box receives a signal that is assigned for storage and buffer per block 200. At this step, some tuning may occur as well. At decision block 204, if the portion of the signal received is not a signal access point, then at block 206, the signal is discarded and the methodology returns to block 202. On the other hand, if the portion of the signal received includes a signal access point, then the methodology advances to block 208 where initial signal preparation, including primary tuning of the signal may occur. In one implementation, the primary tuning may include a portion of receiving, demodulation, decryption, and decoding. Following the primary tuning, the portion of the signal is buffered in the storage at block 210.

At decision block 212, if the channel is not selected for viewing on the television or display associated with the set-top box, then the methodology advances to decision block 214, where if the storage portion is assigned a new channel, the method returns to block 200. Otherwise, if the storage has not been reassigned a channel, the methodology advances to block 216 where additional signal is received and, if the signal is a signal access point, as shown at decision block 218, then at block 220, the previously stored signal portion associated with the previously most recent signal access point is subject to an overwrite prior to the methodology returning to block 208 to conduct a primary tuning on the signal access point prior to storage.

Returning to decision block 218, if the signal portion received is not a signal access point, then the methodology returns to blocks 208 and 210 to execute primary tuning on the signal portion and store the newly received signal portion with previously received the signal portion or portions associated with the recent signal access point.

Returning to decision block 212, if the channel is selected for display on the television associated with the set-top box, then the methodology advances to two processes conducted in parallel. First, at block 224, the signal is retrieved from buffering so that signal preparation may be completed, including secondary tuning occurring at block 226 following by forwarding of the signal to the television or display at block 228. In one implementation, the secondary tuning may include the portion of receiving, demodulation, decryption, and decoding not performed during the primary tuning. By retrieving utilizing a partially tuned signal to complete tuning, delays associated with zap time are mitigated. In one embodiment, tuners not used by the viewing channels are fully tuned and receiving demodulated video and audio streamed. The processor continuously tracks the location of each access point in each buffer. In this implementation, decryption does not occur until the tuner is assigned as the viewing channel.

In parallel to the operations in blocks 224, 226, and 228, at blocks 230, 232, and 234, a signal is received, primary tuning occurs, and the signal is buffered. Following the operations in blocks 224-228 and blocks 230-234, the methodology advances to decision block 236, where if the channel remains selected, the methodology returns to blocks 224-228 and blocks 230-234. Otherwise, the methodology returns to the channel assignment at block 200.

The order of execution or performance of the methods and data flows illustrated and described herein is not essential, unless otherwise specified. That is, elements of the methods and data flows may be performed in any order, unless otherwise specified, and that the methods may include more or less elements than those disclosed herein. For example, it is contemplated that executing or performing a particular element before, contemporaneously with, or after another element are all possible sequences of execution.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A set-top box for changing channels comprising:
a housing securing a television input, a television output, a processor, memory, buffer, a first tuner, and a second tuner therein;
a busing architecture communicatively interconnecting the television input, the television output, the processor, the memory, the storage, the first tuner, and the second tuner therebetween;
the television input configured to receive a source signal from an external source, the source signal including a plurality of channels, each of the plurality of channels having periodic, sequential signal access points that permit tuning initiation;
the television output configured to forward a fully tuned signal to a television;
a first tuner configured to receive and at least partially tune a first channel from the source signal, the first tuner providing a at least partially tuned first channel;
a second tuner configured to receive and at least partially tune a second channel from the source signal, the second tuner providing a at least partially tuned second channel;
the memory accessible to the processor, the memory including processor-executable instructions that, when executed, cause the processor to:
buffer in the buffer the at least partially tuned second channel;
track in the buffer the at least partially tuned second channel beginning at a recent periodic, sequential signal access point;
in response to receiving a channel change instruction, access from the buffer the at least partially tuned second channel beginning at the recent periodic, sequential signal access point;
transform the partially tuned second channel to a fully tuned second channel signal; and
forward, via the television output, the fully tuned second channel signal.

2. The set-top box as recited in claim 1, wherein the at least partially tuned second channel comprises a fully tuned second channel signal.

3. The set-top box as recited in claim 1, wherein the tuned signal further comprises signals selected from the group consisting of the tuned first channel and the tuned second channel.

4. The set-top box as recited in claim 1, wherein prior to the set-top box receiving the channel change instruction, the television output forwards the tuned first channel.

5. The set-top box as recited in claim 1, wherein following the set-top box receiving the channel change instruction, the first tuner is assigned a new channel.

6. The set-top box as recited in claim 1, wherein processor-executable instructions further comprise following the set-top box receiving the channel change instruction, buffer in the storage the first second channel.

7. The set-top box as recited in claim 1, wherein the first tuner provides a tuned first channel consisting of live programming content.

8. The set-top box as recited in claim 1, wherein the first tuner provides a tuned first channel consisting of pre-buffered content.

9. The set-top box as recited in claim 1, wherein the second tuner is dynamically assigned a channel.

10. The set-top box as recited in claim 1, wherein the second tuner is assigned a channel one channel up from the first channel.

11. The set-top box as recited in claim 1, wherein the second tuner is assigned a channel frequently tuned.

12. The set-top box as recited in claim 1, wherein the processor-executable instructions to track in the storage the tuned second channel beginning at the recent, periodic, sequential signal access point further comprises causing the processor to track in the buffer the tuned second channel beginning at the most recent sequential signal access point.

13. The set-top box as recited in claim 1, wherein the processor-executable instructions to track in the buffer the tuned second channel beginning at the recent, periodic, sequential signal access point further comprises causing the processor to:
track in the buffer the tuned second channel beginning at a first periodic, sequential signal access point; and
track in the buffer the tuned second channel beginning at a second periodic, sequential signal access point, the second periodic, sequential signal access point being subsequent in time to the first periodic, sequential signal access point.

14. The set-top box as recited in claim 1, wherein the processor-executable instructions to track in the buffer the tuned second channel beginning at the recent, periodic, sequential signal access point further comprises causing the processor to:
make available for deletion the portion of the buffered tuned second channel in the buffer previous to the most recent periodic, sequential signal access point.

15. The set-top box as recited in claim 1, wherein the processor-executable instructions to track in the buffer the tuned second channel beginning at the recent, periodic, sequential signal access point further comprises causing the processor to:
make available for over-write the portion of the buffered tuned second channel in the buffer previous to the most recent periodic, sequential signal access point.

16. A set-top box for changing channels comprising:
a housing securing a television input, a television output, a processor, memory, a buffer, a first tuner, and a second tuner therein;
a busing architecture communicatively interconnecting the television input, the television output, the processor, the memory, the buffer, the first tuner, and the second tuner therebetween;
the television input configured to receive a source signal from an external source, the source signal including a plurality of channels, each of the plurality of channels having periodic, sequential signal access points that permit tuning initiation;
the television output configured to forward a fully tuned signal to a television;
a plurality of tuners configured to receive and at least partially tune a plurality of channels from the source signal; and
the memory accessible to the processor, the memory including processor-executable instructions that, when executed, cause the processor to:
dynamically assign each of the plurality of tuners to one of the plurality of channels;
for each of the plurality of tuners, buffer in the buffer the at least partially tuned channel;
for each of plurality of tuners, track in the buffer the at least partially tuned channel beginning at a recent periodic, sequential signal access point; and
in response to receiving a channel change instruction to change to a requested channel, locate the buffer associated with the tuner assigned to the requested channel and cause the at least partially tuned channel beginning at the recent periodic, sequential signal access point to be fully tuned;
forward the fully tuned channel.

17. The set-top box as recited in claim 16, further comprising an antenna associated with the busing architecture, the antenna receiving the channel change instruction.

18. The set-top box as recited in claim 16, wherein the memory including processor-executable instructions, when executed, further cause the processor to:
dynamically re-assign at least a portion of the plurality of tuners to the plurality of channels.

19. The set-top box as recited in claim 16, wherein the television output forwards one tuned signal to the television based on one of the plurality of channels while simultaneously pre-buffering at least a second of the plurality of channels for playback.

20. The set-top box as recited in claim 16, wherein the television output forwards one pre-buffered tuned signal to the television based on one of the plurality of channels while simultaneously pre-buffering at least a second of the plurality of channels for playback.

21. The set-top box as recited in claim 16, wherein the at least partially tuned second channel comprises a fully tuned second channel signal.

22. A set-top box for changing channels comprising:
a housing securing a television input, a television output, a processor, memory, buffer, a first tuner, and a second tuner therein;
a busing architecture communicatively interconnecting the television input, the television output, the processor, the memory, the buffer, the first tuner, and the second tuner therebetween;
an antenna associated with the housing and busing architecture, the antenna configured to receive a channel change instruction;
the television input configured to receive a source signal from an external source, the source signal including a plurality of channels, each of the plurality of channels having periodic, sequential signal access points that permit tuning initiation;
the television output configured to forward a fully tuned signal to a television based on one of the plurality of channels while simultaneously pre-buffering at least a second of the plurality of channels for playback;
a plurality of tuners configured to receive and at least partially tune a plurality of channels from the source signal; and
the memory accessible to the processor, the memory including processor-executable instructions that, when executed, cause the processor to:
dynamically assign each of the plurality of tuners to one of the plurality of channels;
for each of the plurality of tuners, buffer in the buffer the tuned channel;
for each of plurality of tuners, track in the buffer the tuned channel beginning at a recent periodic, sequential signal access point;
in response to receiving the channel change instruction to change to a requested channel, locate the buffer associated with the tuner assigned to the requested channel and cause the television output to forward the tuned signal based on the tuned channel in the buffer associated with the tuner assigned to the requested channel beginning at the recent periodic, sequential signal access point; and
dynamically re-assign at least a portion of the plurality of tuners to the plurality of channels.
